(19) United States
(12) Patent Application Publication
(10) Pub. No.: US 2010/0196629 A1
(43) Pub. Date: Aug. 5, 2010

(54) DIMENSIONALLY STABLE MOLDING

(75) Inventors: Julien P. Mourou, Bloomfield Hills, MI (US); Thomas J. Pickett, Troy, MI (US); Paul Hui, Toronto (CA)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/362,961

(22) Filed: Jan. 30, 2009

(51) Int. Cl. B60R 13/02

(52) U.S. Cl. 428/31

(57) ABSTRACT

A vehicle molding includes a first elongated component formed of a first material and a second elongated component formed of a second material. The first material has a first coefficient of linear thermal expansion and the second material has a second coefficient of linear thermal expansion. The second elongated component defines a plurality of holes. A difference between the first coefficient of linear thermal expansion and the second coefficient of linear thermal expansion is at least 20×10⁻⁶ cm/cm ° C. The first material substantially fills the plurality of holes so that the second elongated component is embedded in and interlocked with the first elongated component.

### TECHNICAL FIELD

The present invention generally relates to moldings for vehicles, and more specifically, to extruded moldings for vehicles.

### BACKGROUND OF THE INVENTION

Vehicles often include decorative and/or functional moldings to enhance vehicle aesthetics and/or utility. Such vehicle moldings are often attached to an exterior of the vehicle and therefore may be exposed to an ambient temperature of from −30 to 95° C. during vehicle operation. Problematically, however, some existing vehicle moldings may suffer from poor dimensional stability at such ambient temperatures. For example, some existing vehicle moldings may expand and/or contract upon exposure to such ambient temperatures.

To mitigate poor dimensional stability, existing vehicle moldings may include an insert embedded in the vehicle molding. For example, existing vehicle moldings may include an aluminum foil insert coated with an adhesive. Typically, the aluminum foil insert must be coated before embedding, and the adhesive must be activated before the aluminum foil can adhere to the vehicle molding. Such additional processing steps increase processing time and manufacturing costs of existing vehicle moldings.

Further, other existing vehicle moldings may include an indented steel wire insert. The indented steel wire insert is also typically embedded in the vehicle molding in an attempt to mitigate poor dimensional stability and often includes indented dimples, a zinc coating, and an adhesive coating. However, the zinc coating and adhesive coating must also be applied before embedding, and the zinc coating and adhesive coating increase manufacturing costs of existing vehicle moldings.

### SUMMARY OF THE INVENTION

A vehicle molding includes a first elongated component and a second elongated component. The first elongated component is formed of a first material having a first coefficient of linear thermal expansion. The second elongated component is formed of a second material having a second coefficient of linear thermal expansion and defines a plurality of holes. A difference between the first coefficient of linear thermal expansion and the second coefficient of linear thermal expansion is at least 20×10⁻⁶ cm/cm ° C. The first material substantially fills the plurality of holes so that the second elongated component is embedded in and interlocked with the first elongated component.

In another embodiment, the plurality of holes is disposed in a first row and a second row that is offset with respect to the plurality of holes in the first row.

In another embodiment, the plurality of holes is randomly disposed throughout the second elongated component, and a length of the vehicle molding does not change by more than 1% of an original length when exposed to an ambient temperature of from −30 to 95° C.

The vehicle molding exhibits excellent dimensional stability and stiffness upon exposure to an ambient temperature of from −30 to 95° C. and therefore maximizes aesthetics and utility of the vehicle. In particular, the vehicle molding minimizes expansion and contraction upon exposure to ambient temperature during vehicle operation and therefore minimizes, for example, vehicle door inoperability and irregular vehicle seams due to protruding vehicle moldings. Additionally, since the second elongated component does not require additional coatings or adhesives, the vehicle molding is cost-effective to manufacture.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective fragmentary view of a vehicle door having a vehicle molding configured for attachment to an exterior thereof;

FIG. 2 is a schematic perspective view of a second embodiment of the vehicle molding of FIG. 1;

FIG. 3A is a schematic top view of a second elongated component included in the vehicle moldings of FIGS. 1 and 2 defining a plurality of holes;

FIG. 3B is a schematic top view of the second elongated component of FIG. 3A defining the plurality of holes in an alternate arrangement;

FIG. 3C is a schematic top view of the second elongated component of FIG. 3A defining the plurality of holes in another alternate arrangement;

FIG. 4A is a schematic cross-sectional view of the vehicle molding of FIG. 1 along section line 4-4 including the second elongated component of FIG. 3A embedded in and interlocked with a first elongated component; and

FIG. 4B is an enlarged schematic cross-sectional view of a portion of the vehicle molding of FIGS. 1 and 4A.

### DESCRIPTION OF THE PREFERRED EMBODIMENTS

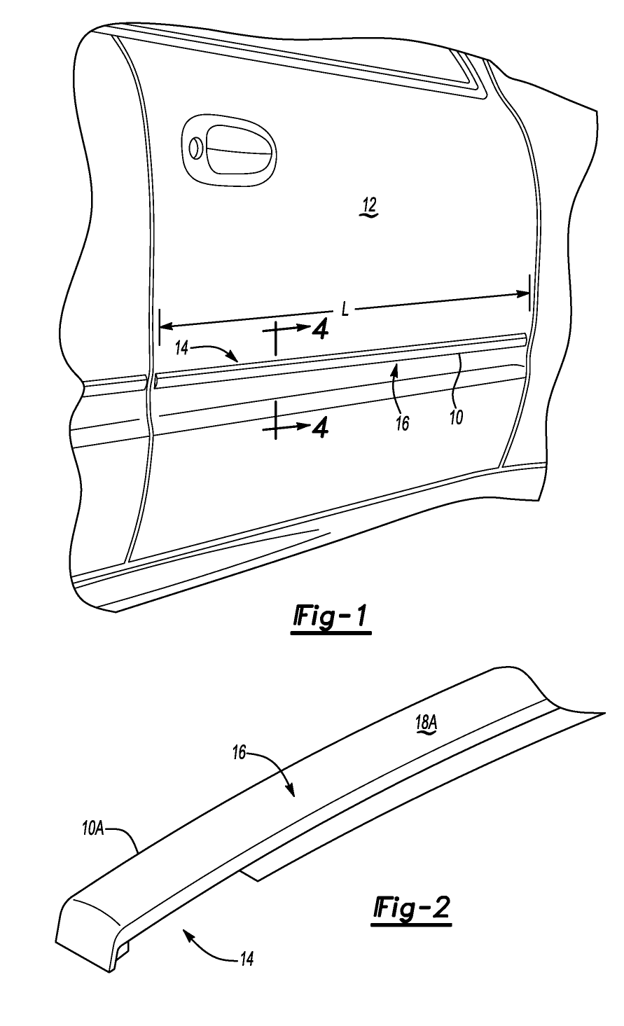

Referring to the drawings, wherein like reference numerals refer to like components, a vehicle molding is shown generally at 10 in FIG. 1. The vehicle molding 10 is preferably useful for automotive applications, such as body molding or roof ditch molding. However, it is to be appreciated that the vehicle molding 10 may also be useful for non-automotive applications, such as, but not limited to, aviation, marine, rail, and recreational vehicle applications.

Referring to FIG. 1, the vehicle molding 10 may be configured for attachment to an exterior of a vehicle 12, specifically a vehicle door. For example, in one embodiment, the vehicle molding 10 is a body molding useful for enhancing aesthetics of the vehicle 12. Referring to FIG. 2, in another embodiment, the vehicle molding 10A is a roof ditch molding useful for covering a joint between a roof (not shown) and a side panel (not shown) of the vehicle 12. The vehicle moldings 10,10A preferably each have a first surface 14 configured for attachment to the vehicle 12 and a second surface 16 disposed opposite the first surface 14. The first surface 14 of the vehicle moldings 10,10A may attach to the vehicle 12 and be hidden from view to an observer of the vehicle 12, whereas the second surface 16 may be visible to the observer of the vehicle 12. The vehicle moldings 10,10A may be attached to the vehicle 12 via, for example, screws, bolts, clips, adhesives, welds, an interference fit, or combinations thereof.

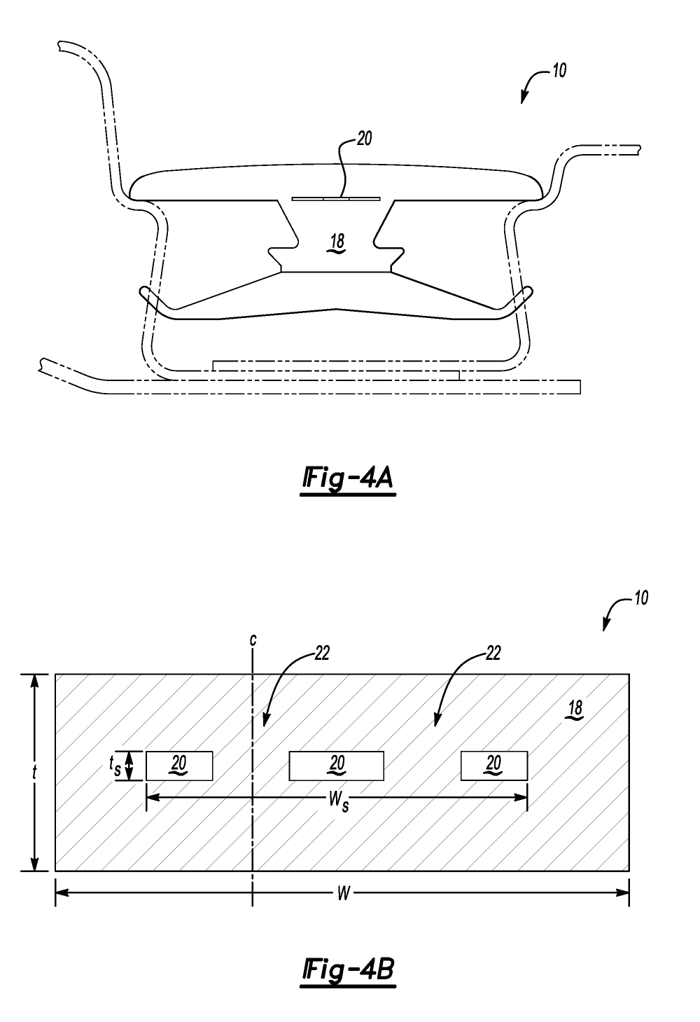

Referring to FIG. 4A, the vehicle molding 10 includes a first elongated component 18 formed of a first material. The first elongated component 18 preferably forms a body of the vehicle molding and may be shaped according to desired placement on the vehicle 12. For example, in the embodiment including the body molding, the first elongated component 18 may include a convex or concave shape, ridges, striping, or combinations thereof according to vehicle styling. Likewise, referring to FIG. 2, in the embodiment including the roof ditch molding, the first elongated component 18A may be contoured and/or beveled to fit between vehicle joints (not shown) and side panels (not shown).

The first elongated components 18 and 18A may be formed from extrusion, as set forth in more detail below. For example, the first elongated components 18 and 18A may be formed from co-extrusion. Consequently, the first elongated components 18, 18A may have any shape. The first elongated components 18, 18A may have a rectangular or box shape; a complex shape including flanges, arms, and notches; a generally cylindrical or hexagonal shape; and combinations thereof. Preferably, the first elongated components 18, 18A extend longitudinally. That is, referring to FIGS. 1 and 4B, and indicated with respect to vehicle molding 10, a length, L, of the first elongated component 18 is preferably greater than a width, W, of the first elongated component 18.

The first material has a first coefficient of linear thermal expansion. The first coefficient of linear thermal expansion is preferably at least 50×10⁻⁶, more preferably at least 75×10⁻⁶ cm/cm ° C. as measured in accordance with ASTM D696. The first material may be any suitable material for extrusion and for automotive applications requiring exposure to an ambient temperature of from −30 to 95° C. That is, as set forth in more detail below, the first material is preferably extrudable.

For example, the first material may be a polymer. In particular, the first material may be selected from the group of polyvinyl chloride, thermoplastic vulcanizates, thermoplastic elastomers, polyethylene, polypropylene, nylon, vinyl, and combinations thereof. Alternatively, the first material may be a glass, such as, but not limited to soda-lime glass, borosilicate glass, aluminosilicate glass, and fused silica glass. The first material may be a metal, such as, but not limited to, steel and aluminum. Further, the first material may be a combination of one or more polymers, glasses, and metals. The first material may also be coated. For example, the first material may be coated with a pigmented coating composition, a clearcoat, an electrocoat, chrome, and combinations thereof.

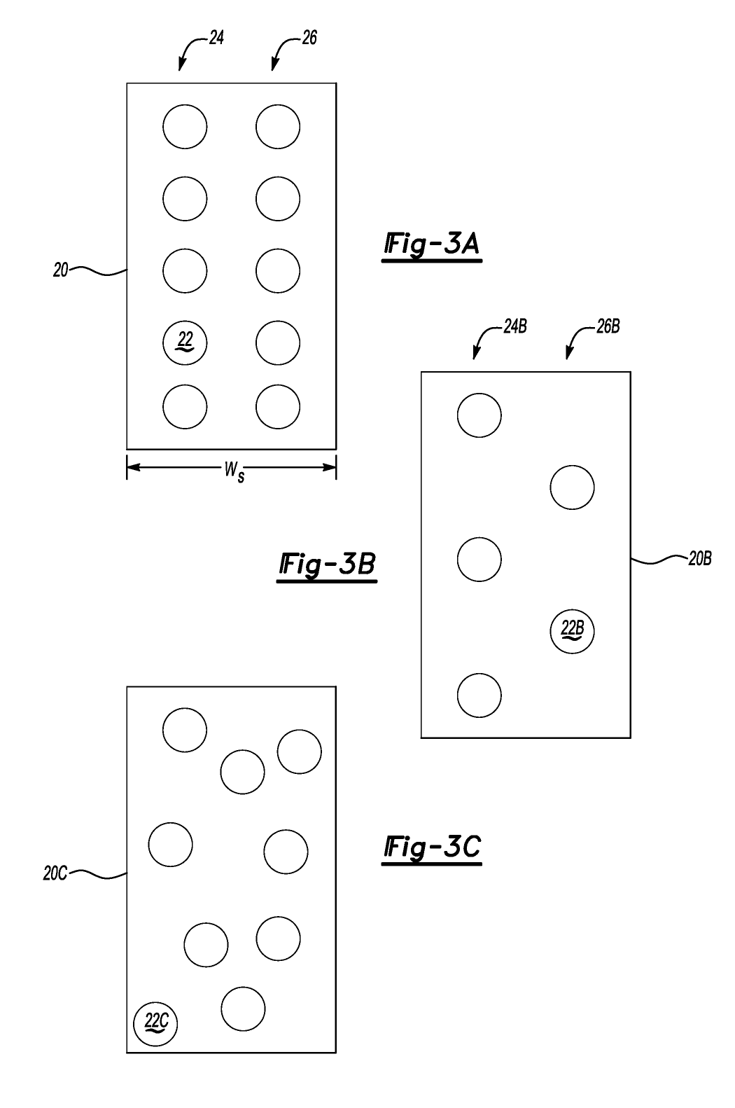

The vehicle moldings 10,10A include a second elongated component, shown generally at 20 in FIG. 3A for vehicle molding 10. The second elongated component 20 is formed of a second material and is preferably configured for insertion into the first elongated components 18, 18A during extrusion, e.g., co-extrusion, as set forth in more detail below. That is, the second elongated component 20 is preferably inserted into the first elongated components 18, 18A to form, e.g., extrude, the vehicle moldings 10,10A.

Since the second elongated component 20 preferably forms an insert of the vehicle moldings 10,10A, the second elongated component 20 may be shaped according to any desired shape of the first elongated components 18, 18A. For example, the second elongated component 20 may be generally flat or box-shaped. Referring to FIG. 4B, the second elongated component 20 preferably has a surface area and a uniform thickness, tₛ. In particular, the second elongated component 20 preferably has a thickness, tₛ, of from 0.2 to 1, more preferably 0.3 to 0.8 mm. Referring to FIG. 4B, the second elongated component 20 may have a width, Wₛ, of from 0.1 to 1 mm and a length of from 10 to 100 cm. As indicated in FIG. 1 with respect to vehicle molding 10, it is to be appreciated that the length of the second elongated component 20 is preferably selected according to the length, L, of the first elongated component 18. For example, the length of the second elongated component 20 may be approximately equal to the length, L, of the first elongated component 18.

The second material has a second coefficient of linear thermal expansion. The second coefficient of linear thermal expansion is preferably less than 30×10⁻⁶, more preferably less than 20×10⁻⁶ cm/cm ° C. as measured in accordance with ASTM D696. Further, a difference between the first coefficient of linear thermal expansion and the second coefficient of linear thermal expansion is at least 20×10⁻⁶, more preferably at least 30×10⁻⁶ cm/cm ° C. The second material may be any suitable material for extrusion and for automotive applications requiring exposure to an ambient temperature of from −30 to 95° C. That is, as set forth in more detail below, the second elongated component 20 formed of the second material is preferably extrudable. In one embodiment, the second material is a metal. For example, the second material may be selected from the group of steel, aluminum, copper, iron, and combinations thereof.

Referring to FIG. 3A, the second elongated component 20 defines a plurality of holes 22. For example, the second elongated component 20 may define two holes 22, wherein one of each hole 22 is preferably disposed at each end of the second elongated component 20. Alternatively, referring to FIG. 3A, the second elongated component 20 may define more than two holes 22.

Referring to FIG. 4B, the plurality of holes 22 may extend through the thickness, tₛ, of the second elongated component 20 so that a center axis C of each of the plurality of holes 22 is disposed substantially perpendicular to both the length and the width, Wₛ, of the second elongated component 20. Alternatively, the plurality of holes 22 may extend through the width, Wₛ, of the second elongated component 20 so that the center axis C of each of the plurality of holes 22 is disposed substantially perpendicular to both the length and the thickness, tₛ, of the second elongated component 20. As used herein, the terminology “substantially” is used to represent the inherent degree of uncertainty that may be attributed to any quantitative comparison, value, measurement, or other representation. As such, it refers to an arrangement of elements or features that, while in theory would be expected to exhibit exact correspondence or behavior, may in practice embody something slightly less than exact. The terminology also represents the degree by which a quantitative representation may vary from a stated reference without resulting in a change in the basic function of the subject matter at issue. Therefore, it is contemplated that the plurality of holes 22 may be slightly less than or more than perpendicularly disposed to the length, the width, Wₛ, and/or the thickness, tₛ, of the second elongated component 20. It is to be appreciated that the plurality of holes 22 preferably extends completely through the thickness, tₛ, and/or the width, Wₛ, of the second elongated component 20.

Referring to FIG. 3A, the plurality of holes 22 may be disposed in a first row 24 and a second row 26 that is substantially parallel to and adjacent the first row 24. That is, the plurality of holes 22 may be arranged in at least two adjacent rows. It is to be appreciated that the first row 24 and the second row 26 may extend either length-wise or width-wise along the second elongated component 20. Preferably, an edge of an individual hole 22 in the first row 24 does not abut an edge of an individual hole 22 in the second row 26. The second elongated component 20 may include the plurality of holes 22 disposed in a plurality of parallel rows. For example, the second elongated component 20 may include the plurality of holes 22 disposed in three or more parallel rows extending length-wise along the second elongated component 20. Similarly, the second elongated component 20 may include the plurality of holes 22 disposed in three or more parallel rows extending width-wise along the second elongated component 20. Referring to FIGS. 3A and 4B, the plurality of holes 22 may not be offset with respect to the plurality of holes 22 in the second row 26. Stated differently, each center axis C of the plurality of holes 22 in the first row 24 may be aligned with each center axis C of a corresponding adjacent plurality of holes 22 in the second row 26.

The plurality of holes 22 is typically configured to act as anchors for the first material during extrusion and as such may have any shape. For example, the plurality of holes 22 may be oval-, box-, groove-, slot-, or rectangular-shaped. Further, an individual hole 22 may have a same or different shape than one or more other individual holes 22. The plurality of holes preferably 22 has a circular shape, and each hole 22 preferably has a diameter of from 0.05 to 0.75 mm. The plurality of holes 22 preferably occupies less than half, more preferably less than one quarter of the surface area of the second elongated component 20 so as to maintain a structural integrity and tensile strength of the second elongated component 20. Preferably, the plurality of holes 22 does not extend through an edge of the second elongated component 20. However, the plurality of holes 22 may extend through the edge of the second elongated component 20, such as, for example, when the vehicle molding 10 is cut.

The second elongated component 20 is preferably substantially free from a coating. That is, the second elongated component 20 is preferably not coated with zinc or any other surface treatment. Further, the second elongated component 20 is also preferably substantially free from an adhesive. That is, the second elongated component 20 is preferably not coated with an adhesive and does not require any adhesive or activation to interlock with the first elongated component 18, as set forth in more detail below. Since the second elongated component 20 does not require additional coatings or adhesives, the vehicle molding 10 is cost-effective to manufacture.

The first material and the second elongated component 20 are preferably extrudable. That is, the second elongated component 20 is preferably configured for insertion into the first elongated component 18 during extrusion. As used herein, the terminology extrusion refers to a process by which a material or a plurality of materials, e.g., the first material and the second elongated component 20, are fed together through an extruder to produce a combined product, e.g., the vehicle molding 10. Any extrusion or process suitable for producing a combined product may be suitable. For example, the first material and the second elongated component 20 may be co-extruded. Suitable extruders may include one or more extrusion dies that may be configured to produce a desired shape of the vehicle molding 10. Without intending to be limiting, in an exemplary extrusion process, the first material and a continuous length of the second elongated component 20 are fed into the extruder. That is, the first material and the second elongated component 20 are extruded in the extruder. The first material substantially fills the plurality of holes 22 so that the second elongated component 20 is embedded in and interlocked with the first elongated component 18. The second elongated component 20 may be in a same plane throughout the first elongated component 18, e.g., the second elongated component 20 may pass through a central plane of the first elongated component 18.

Upon exit from the extrusion die, the resulting vehicle moldings 10,10A, including the second elongated component 20 embedded in and interlocked with the first elongated components 18,18A, may be cooled and/or cut to a desired length for storage or attachment to the vehicle 12. The vehicle moldings 10,10A may be straight cut, beveled, or angled cut according to eventual end use.

Referring to FIGS. 4A and 4B and indicated with respect to vehicle molding 10, upon extrusion, the first material of the first elongated component 18 preferably fills the plurality of holes 22 defined by the second elongated component 20 so that the plurality of holes 22 anchor and interlock the second elongated component 20 with the first elongated component 18. The second elongated component 20 is embedded and interlocked with the first elongated component 18 to minimize a change in length of the vehicle molding 10 upon exposure to an ambient temperature of from −30 to 95° C. Stated differently, the second elongated component 20 preferably reinforces the first elongated component 18 and provides dimensional stability and stiffness to the vehicle molding 10.

The second elongated component 20 therefore preferably minimizes any tendency of the first elongated component 18 to expand and/or contract upon exposure to ambient temperatures of from −30 to 95° C. and provides excellent length control to the vehicle molding 10. Since a difference between the first coefficient of linear thermal expansion and the second coefficient of linear thermal expansion is preferably at least 20×10⁻⁶, more preferably at least 30×10⁻⁶ cm/cm ° C., the second elongated component 20 expands and/or contracts to a lesser degree than the first elongated component 18. Thus, if the first elongated component 18 attempts to expand and/or contract, the second elongated component 20 minimizes any change in length, L, of the vehicle molding 10 and stabilizes the vehicle molding 10. Without intending to be limited by theory, the difference between the coefficients of linear thermal expansion of the first material and the second material may allow one material to act as a heat sink and absorb heat. Therefore, the length, L, of the vehicle molding 10 preferably does not change by more than 1% of an original length when exposed to an ambient temperature of from −30 to 95° C.

Referring to FIG. 3B, in another embodiment, a second elongated component 20B defines a plurality of holes 22B disposed in a first row 24B and a second row 26B that is offset with respect to the plurality of holes 22B in the second row 26B. That is, each hole 22B in the first row 24B is not aligned width-wise or length-wise with a hole 22B in the second row 26B. Stated differently, each of the plurality of holes 22B in the first row 24B may not have a corresponding adjacent hole 22B in the second row 26B.

Referring to FIG. 3C, in yet another embodiment, a second elongated component 20C defines a plurality of holes 22C randomly disposed throughout the second elongated component 20C. In this embodiment, it is to be appreciated that the plurality of holes 22C may not be arranged as in the first row 24 and the second row 26 of FIG. 3A, but may be scattered throughout the second elongated component 20C as indicated generally in FIG. 3C.

The vehicle moldings 10,10A exhibit excellent dimensional stability and stiffness upon exposure to an ambient temperature of from −30 to 95° C. and therefore maximize aesthetics and utility of the vehicle 12. In particular, the vehicle moldings 10,10A minimize expansion and contraction upon exposure to ambient temperature during vehicle operation and therefore minimize, for example, vehicle door inoperability and irregular vehicle seams due to protruding moldings. Advantageously, the plurality of holes 22,22B,22C substantially filled with the first material, provides the vehicle moldings 10,10A with excellent dimensional stability as compared to a second elongated component only including dimples or indentations. That is, the first elongated components 18, 18A do not slide and/or slip over the second elongated component 20, 20B, 20C upon exposure to the ambient temperature of from −30 to 95° C. because the plurality of holes 22,22B,22C interlock the second elongated components 20,20B,20C with the first elongated components 18,18A. Additionally, since the first material and the second elongated components 20,20B,20C are extrudable, and since the second elongated component 20,20B,20C does not require additional coatings or adhesives, the vehicle moldings 10,10A are cost-effective to manufacture.

While the best modes for carrying out the invention have been described in detail, those familiar with the art to which this invention relates will recognize various alternative designs and embodiments for practicing the invention within the scope of the appended claims.

1. A vehicle molding comprising:
a first elongated component formed of a first material having a first coefficient of linear thermal expansion; and
a second elongated component co-extruded with said first elongated component and formed of a second material having a second coefficient of linear thermal expansion and defining a plurality of holes;
wherein said second elongated component has a thickness of from 0.2 mm to 1 mm;
wherein a difference between said first coefficient of linear thermal expansion and said second coefficient of linear thermal expansion is at least 20×10⁻⁶ cm/cm ° C.; and
wherein said first material substantially fills said plurality of holes so that said second elongated component is embedded in and interlocked with said first elongated component.

2. The vehicle molding of claim 1, wherein a length of the vehicle molding does not change by more than 1% of an original length when exposed to an ambient temperature of from −30 to 95° C.

3. (canceled)

4. The vehicle molding of claim 1, wherein said plurality of holes extends through a thickness of said second elongated component so that a center axis of each of said plurality of holes is disposed substantially perpendicular to both a length and a width of said second elongated component.

5. The vehicle molding of claim 4, wherein said plurality of holes is disposed in a first row and a second row that is substantially parallel to and adjacent said first row.

6. The vehicle molding of claim 1, wherein said plurality of holes occupies less than half of a surface area of said second elongated component.

7. The vehicle molding of claim 1, wherein said second elongated component is substantially free from a coating.

8. The vehicle molding of claim 1, wherein said second elongated component is substantially free from an adhesive.

9. The vehicle molding of claim 1, wherein said first coefficient of linear thermal expansion is at least 50×10⁻⁶ cm/cm ° C. as measured in accordance with ASTM D696.

10. The vehicle molding of claim 9, wherein said second coefficient of linear thermal expansion is less than 30×10⁻⁶ cm/cm ° C. as measured in accordance with ASTM D696.

11. The vehicle molding of claim 1, having a first surface configured for attachment to a vehicle and a second surface disposed opposite said first surface.

12. The vehicle molding of claim 1, wherein said second elongated component is configured for insertion into said first elongated component during extrusion.

13. (canceled)

14. The vehicle molding of claim 1, wherein said first material is a polymer.

15. The vehicle molding of claim 1, wherein said second material is a metal.

16. The vehicle molding of claim 1, wherein said vehicle molding is a body molding.

17. The vehicle molding of claim 1, wherein said vehicle molding is a roof ditch molding.

18. A vehicle molding comprising:
a first elongated component formed of a first material having a first coefficient of linear thermal expansion; and
a second elongated component co-extruded with said first elongated component and formed of a second material having a second coefficient of linear thermal expansion and defining a plurality of holes disposed in a first row and a second row that is offset with respect to said plurality of holes in said first row;
wherein said second elongated component has a thickness of from 0.2 mm to 1 mm;
wherein a difference between said first coefficient of linear thermal expansion and said second coefficient of linear thermal expansion is at least 20×10⁻⁶ cm/cm ° C.; and
wherein said first material substantially fills said plurality of holes so that said second elongated component is embedded in and interlocked with said first elongated component.

19. The vehicle molding of claim 18, wherein a length of the vehicle molding does not change by more than 1% of an original length when exposed to an ambient temperature of from −30 to 95° C.

20. A vehicle molding comprising:
a first elongated component formed of a first material having a first coefficient of linear thermal expansion; and
a second elongated component co-extruded with said first elongated component and formed of a second material having a second coefficient of linear thermal expansion and defining a plurality of holes randomly disposed throughout said second elongated component;
wherein said second elongated component has a thickness of from 0.2 mm to 1 mm;
wherein a difference between said first coefficient of linear thermal expansion and said second coefficient of linear thermal expansion is at least 20×10⁻⁶ cm/cm ° C.;
wherein said first material substantially fills said plurality of holes so that said second elongated component is embedded in and interlocked with said first elongated component; and
wherein a length of said vehicle molding does not change by more than 1% of an original length when exposed to an ambient temperature of from −30 to 95° C.
